(19) United States
(12) Patent Application Publication
(10) Pub. No.: US 2026/0158618 A1
(43) Pub. Date: Jun. 11, 2026

(54) QUICK-DETACHABLE DUAL-PURPOSE ABRASIVE PAPER GRINDING BOARD AND USING METHOD

(71) Applicant: ZHEJIANG KC MECHANICAL & ELECTRICAL CO.,LTD., Zhejiang (CN)

(72) Inventors: Xiaowei SUN, Zhejiang (CN); Haoyu YING, Zhejiang (CN); Qunshuai SUN, Zhejiang (CN)

(73) Assignee: ZHEJIANG KC MECHANICAL & ELECTRICAL CO.,LTD., Zhejiang (CN)

(21) Appl. No.: 19/055,423

(22) Filed: Feb. 17, 2025

(30) Foreign Application Priority Data
Dec. 10, 2024 (CN) 202411809645.X

(51) Int. Cl. B24D 15/02; B25G 3/38

(52) U.S. Cl. CPC B24D 15/023; B25G 3/38

(57) ABSTRACT

The present disclosure provides a quick-detachable dual-purpose abrasive paper grinding board and a using method. The abrasive paper grinding board includes a grinding board bottom board, a quick-detachable grasping head and a movable locking member; a mounting groove is formed in an upper end face of the grinding board bottom board; the quick-detachable grasping head is provided with a positioning bottom board; the movable locking member is rotatably mounted on the grinding board bottom board and used for locking the positioning bottom board; and at the unlocking position, the movable locking member is detached from the positioning bottom board, and the grip quick-detachable head may be removed from the mounting groove. In the present disclosure, quick locking and detaching of the quick-detachable head may be achieved through the movable locking member, and replacement is convenient.

### TECHNICAL FIELD

The present application relates to the technical field of abrasive paper grinding boards, in particular to a quick-detachable dual-purpose abrasive paper grinding board and a using method.

### BACKGROUND

Abrasive paper is a material for grinding, and an abrasive paper grinding board is used for mounting abrasive paper, so as to smooth and trim a surface of an object, and is especially suitable for trimming a putty wall. The abrasive paper template may change different types of abrasive paper, so as to adapt to different scenarios for use, achieving an optimal grinding effect.

At present, most of abrasive paper grinding boards on the market adopt a grip grasping type structure, and the abrasive paper grinding board of the grip grasping type structure has certain limitations in use function, such as its difficulty in trimming higher putty walls. Therefore, an abrasive paper grinding board equipped with a grip grasping mechanism and an extension bar grasping mechanism may be designed to deal with different using scenarios.

### SUMMARY

### (1) Technical Problem to be Solved

In view of this, the present application provides a quick-detachable dual-purpose abrasive paper grinding board and a using method, not only can optionally mount a grip quick-detachable head, but also can optionally mount an extension bar quick-detachable head. Quick locking and detaching of the quick-detachable head may be achieved through a movable locking member.

### (2) Technical Solution

An embodiment of the present specification provides the following technical solution:

An embodiment of the present specification provides a quick-detachable dual-purpose abrasive paper grinding board, including: a grinding board bottom board, paper clamping boards, a quick-detachable grasping head and a movable locking member; the grinding board bottom board is used for mounting abrasive paper; a mounting groove is formed in an upper end face of the grinding board bottom board in a length direction in an extension mode; the paper clamping boards are symmetrically and movably mounted at an upper end of the grinding board bottom board, and used for clamping or releasing the abrasive paper; the quick-detachable grasping head is detachably mounted in the mounting groove; the quick-detachable grasping head includes a grip quick-detachable head or an extension bar quick-detachable head, and the grip quick-detachable head or the extension bar quick-detachable head is provided with a positioning bottom board used for quick-detaching positioning; the movable locking member is rotatably mounted on the grinding board bottom board, and used for locking the positioning bottom board; the movable locking member has an unlocking position and a locking position, at the locking position, the movable locking member locks the positioning bottom board inside the mounting groove; and at the unlocking position, the movable locking member is detached from the positioning bottom board, and the grip quick-detachable head or the extension bar quick-detachable head may be removed from the mounting groove.

In this solution, an operator may select to use the grip quick-detachable head or the extension bar quick-detachable head according to actual application scenarios, the two quick-detachable heads are detachably mounted inside the mounting groove of the grinding board bottom board through the positioning bottom board, locking fixing or unlocking detaching is achieved through the rotation of the movable locking member, therefore, the movable locking member has the unlocking position and the locking position, when the movable locking member is at the unlocking position, the corresponding grip quick-detachable head or extension bar quick-detachable head may be directly removed, detaching, mounting and replacement are convenient, and when the abrasive paper grinding board needs to grind a putty wall at a higher position or a suspended putty wall, the extension bar quick-detachable head is needed at the moment, and processing of a surface of a higher or farther object is achieved through an extension bar of the extension bar quick-detachable head.

In some embodiments, the movable locking member includes a locking dog which is eccentrically arranged, a first locking groove is formed in a side end of the positioning bottom board, and the first locking groove is inwards concave; by rotating the locking dog of the movable locking member, the locking dog and the first locking groove are locked or detached; the locking dog is arranged extending in a width direction of the grinding board bottom board, and the first locking groove is arranged extending in a width direction of the grip quick-detachable head; and/or, one end of the locking dog is connected with an eccentric handle, and the locking dog and the first locking groove are driven to be locked or detached by rotating the eccentric handle; and the eccentric handle is provided with a locking face, and when the movable locking member is at the locking position, the locking face is locked and attached on the upper end face of the grinding board bottom board.

In this solution, the movable locking member includes the locking dog and the eccentric handle, the rotation of the locking dog is achieved by rotating the eccentric handle, when the eccentric handle of the movable locking member rotates into the locking position, the locking face of the eccentric handle is attached and self-locked on the grinding board bottom board, thus, if the eccentric handle is not reversely rotated, the locking dog of the movable locking member will always compress and lock to an interior of the corresponding first locking groove of the positioning bottom board.

In some embodiments, a second locking groove is formed in a side end of the positioning bottom board away from the first locking groove, the second locking groove is inwards concave, the mounting groove is provided with a clamping shaft capable of being clamped with the second locking groove on a side away from the movable locking member, the clamping shaft is arranged extending in the width direction of the grinding board bottom board, and the second locking groove is arranged extending in the width direction of the grip quick-detachable head; and when the positioning bottom board is mounted, the second locking groove in one end of the positioning bottom board is clamped into the clamping shaft, and the movable locking member is rotated to enable the locking dog to make contact with the first locking groove so as to be clamped.

In this solution, the side of the positioning bottom board away from the first locking groove is matched with the clamping shaft at the mounting groove through the second locking groove to achieve primary positioning, and then the locking dog of the movable locking member is in lock fit with the first locking groove of the positioning bottom board to achieve locking and positioning of the entire positioning bottom board. In this solution, the clamping shaft and the locking dog are arranged in parallel, the clamping shaft is an optical axis, and the locking dog is an optical axis with a notch.

In some embodiments, the grip quick-detachable head includes the positioning bottom board and a grip for an operator to grasp; and/or, the grip of the grip quick-detachable head is integrally molded with the positioning bottom board.

In this solution, the grip quick-detachable head is provided with the grip for the operator to directly grasp, and its grip may be integrally molded with the positioning bottom board.

In some embodiments, the extension bar quick-detachable head includes the positioning bottom board and an extension bar member in hinged connection through a universal joint.

In this solution, the extension bar quick-detachable head may grind a surface of a farther object, its extension bar member is similar to a mop rod of a household flat mop, and the extension bar member may achieve rotation adjustment in a front-rear direction or in a left-right direction relative to the positioning bottom board.

In some embodiments, a guide groove is formed in a bottom of the positioning bottom board in a length direction in a cut-through mode, and a guide protrusion capable of being matched with the guide groove is arranged at a bottom of the mounting groove.

In this solution, the guide groove is formed in a middle position of a bottom face of the positioning bottom board, the guide protrusion is arranged at a middle position of an inner wall of the mounting groove, and the positioning bottom board is centered and positioned through the cooperation of the guide groove and the guide protrusion.

In some embodiments, control knobs are rotatably mounted on the paper clamping boards, downwards-pressing cam portions are arranged at lower ends of the control knobs, and the downwards-pressing cam portions are used for downwards pressing paper clamping claws of the paper clamping boards to be close to or away from the upper end face of the grinding board bottom board, so as to clamp or release the abrasive paper; and/or, inwards-concave clamping grooves corresponding to the paper clamping claws of the paper clamping boards are formed in the upper end face of the grinding board bottom board; sink grooves used for positioning the paper clamping boards are further formed in the upper end face of the grinding board bottom board; and/or, the control knobs are rotatably mounted on the grinding board bottom board through mounting bolts and guide sleeves.

In this solution, the grinding board bottom board is directly in contact with the abrasive paper, two ends of the abrasive paper are folded to the upper end face of the grinding board bottom board, and then the two ends of the abrasive paper are compressed by downwards pressing the paper clamping boards. The paper clamping claws of the paper clamping boards are downwards pressed through the rotation of the control knobs, such that the paper clamping claws clamp the abrasive paper to the grinding board bottom board; and by arranging the inwards-concave clamping grooves, further locking and positioning of the abrasive paper is facilitated, such that the abrasive paper is not prone to releasing from the inwards-concave clamping grooves.

An embodiment of the present specification further provides a using method of a quick-detachable dual-purpose abrasive paper grinding board, implemented based on the above-mentioned quick-detachable dual-purpose abrasive paper grinding board, and a grip quick-detachable head or an extension bar quick-detachable head is optionally mounted on a grinding board bottom board;
when the grip quick-detachable head is selected to use, firstly the grip quick-detachable head is placed into a mounting groove of the grinding board bottom board; secondly a second locking groove of a positioning bottom board of the grip quick-detachable head is clamped at a clamping shaft on one side of the mounting groove for primary positioning; then an eccentric handle of a movable locking member is rotated to enable a locking dog to be in lock fit with a first locking groove of the positioning bottom board corresponding to the grip quick-detachable head, the movable locking member enters a locking position, and at the moment, an operator may directly grasp a grip of the grip quick-detachable head by hand for use; and
when the grip quick-detachable head is replaced with the extension bar quick-detachable head, the eccentric handle of the movable locking member is reversely rotated to enable the locking dog to be detached from the first locking groove in one side of the grip quick-detachable head, and in a process of removing the grip quick-detachable head upwards, the clamping shaft is detached from the second locking groove of the corresponding positioning bottom board; and then the extension bar quick-detachable head is placed and locked, and at the moment, the operator may directly grasp an extension bar member of the extension bar quick-detachable head by hand for use.

In some embodiments, a mounting method of the extension bar quick-detachable head is the same as that of the grip quick-detachable head; firstly the extension bar quick-detachable head is placed into the mounting groove of the grinding board bottom board, and at the moment, the positioning bottom board of the extension bar quick-detachable head is placed into the mounting groove; secondly the second locking groove of the positioning bottom board corresponding to the extension bar quick-detachable head is clamped to the clamping shaft on one side of the mounting groove for primary positioning; then the eccentric handle of the movable locking member is rotated to enable the locking dog to be in lock fit with the first locking groove of the positioning bottom board corresponding to the extension bar quick-detachable head, and the movable locking member enters a locking position; and/or, when the positioning bottom board corresponding to the grip quick-detachable head or the extension bar quick-detachable head is placed into the mounting groove, the guide groove in the bottom of the positioning bottom board is matched with the guide protrusion in the mounting groove; and/or, the locking dog and the clamping shaft are respectively arranged extending in a width direction of the grinding board bottom board.

In some embodiments, when the abrasive paper is mounted, two ends of the abrasive paper are folded into inwards-concave clamping grooves in an upper end face of the grinding board bottom board, and control knobs on paper clamping boards are rotated to enable downwards-pressing cam portions of the control knobs to downwards press paper clamping claws of the paper clamping boards, so that the paper clamping claws are in contact with and compress the abrasive paper into the inwards-concave clamping grooves.

### (3) Beneficial Effects

Compared with the prior art, the beneficial effects capable of being achieved by the embodiments of the present specification by adopting the above at least one technical solution at least include: the present disclosure is equipped with the grip quick-detachable head and the extension bar quick-detachable head, the extension bar member of the extension bar quick-detachable head may grind a surface of a farther object, the extension bar member may achieve rotation adjustment in a front-rear direction or in a left-right direction relative to the positioning bottom board, however, the grip of the grip quick-detachable head may be directly grasped by a palm; the two quick-detachable heads are detachably mounted inside the mounting groove of the grinding board bottom board through the positioning bottom board, locking fixing or unlocking detaching of the two quick-detachable heads is achieved through the rotation of the movable locking member, mounting and detaching of the quick-detachable heads are convenient, and quick-mounting and quick-detaching functions of the two quick-detachable heads are achieved; according to the present disclosure, through the cooperation of the first locking groove of the positioning bottom board with the locking dog, and through the cooperation of the second locking groove of the positioning bottom board with the clamping shaft, the positioning bottom board cannot be directly removed from the mounting groove; and according to the present disclosure, the paper clamping claws of the paper clamping boards may be downwards pressed by rotating the downwards-pressing cam portions of the control knobs, such that the paper clamping claws clamp the abrasive paper into the inwards-concave clamping grooves in the grinding board bottom board.

### BRIEF DESCRIPTION OF FIGURES

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a space diagram of equipping a grip quick-detachable head in the present application.

FIG. 2 is an explosive view of a grip quick-detachable head and a grinding board bottom board in the present application.

FIG. 3 is a space diagram of equipping an extension bar quick-detachable head in the present application.

FIG. 4 is an explosive view of an extension bar quick-detachable head and a grinding board bottom board in the present application.

FIG. 5 is a space diagram of a bottom viewing angle of a grip quick-detachable head in the present application.

FIG. 6 is a space diagram of a bottom viewing angle of a positioning bottom board of an extension bar quick-detachable head in the present application.

FIG. 7 is a space diagram of a grinding board bottom board in the present application.

FIG. 8 is a front section view of an abrasive paper grinding board equipped with a grip quick-detachable head in the present application.

FIG. 9 is a left section view of an abrasive paper grinding board equipped with a grip quick-detachable head in the present application.

FIG. 10 is a front section view of an abrasive paper grinding board equipped with an extension bar quick-detachable head in the present application.

FIG. 11 is a left section view of an abrasive paper grinding board equipped with an extension bar quick-detachable head in the present application.

FIG. 12 is a space diagram of a movable locking member in the present application.

FIG. 13 is a related explosive view of control knobs and paper clamping boards in the present application.

1, Grinding board bottom board; 2, Paper clamping board; 3, Grip quick-detachable head; 4, Extension bar quick-detachable head; 5, Positioning bottom board; 6, Movable locking member; 7, Clamping shaft; 8, Control knob; 101, Mounting groove; 102, Guide protrusion; 103, Inwards-concave clamping groove; 104, Sink groove; 105, Vertical board; 106, Mounting hole, 201, Paper clamping claw; 301, Grip; 401, Universal joint; 402, Extension bar member; 403, Hinged shaft; 501, First locking groove; 502, Second locking groove; 503, Guide groove; 601, Locking dog; 602, Eccentric handle; 603, Notch; 801, Downwards-pressing cam portion; 802, Mounting bolt; and 803, Guide sleeve.

### DETAILED DESCRIPTION

The following describes the embodiments of this application with reference to the accompanying drawings.

The implementation manners of the present application will be described below with reference to specific examples. Those skilled in the art may easily understand other advantages and effects of the present application by the contents disclosed in the present specification. Apparently, the described embodiments are merely a part of embodiments of the present application and are not all the embodiments. The present application may also be implemented or applied through other different specific implementation manners. Various modifications or changes may also be made on the details in the present specification without departing from the spirit of the present application based on different viewpoints and applications. It should be noted that in the absence of conflicts, the following embodiments and features in the embodiments may be combined mutually. Based on the embodiments in the present application, all other embodiments obtained by those of ordinary skill in the art without creative work fall within the scope of protection of the present application.

It should be noted that various aspects of the embodiments within the scope of the appended claims are described below. Apparently, the aspects described in the text may be embodied in various forms, and any specific structure and/or function described in the text is merely illustrative. Based on the present application, those skilled in the art may understand that one aspect described in the text may be separately implemented with any other aspects, and may further combine two or more than two of these aspects in various manners. For example, any number and aspect stated in the text may be used for implementing a device and/or practicing a method. In addition, other structures and/functions expect one or more aspects stated in the text may be used for implementing the device and/or practicing the method.

It should also be noted that the drawings provided in the following embodiments only schematically illustrate the basic concept of the present application, and the drawings show only the components related to the present application instead of being drawn according to the quantity, shape and size of the components in actual implementation. In actual implementation, the shape, quantity and proportion of the components may be changed at will, and the layout of components may be more complicated.

In addition, in the following description, specific details are provided for facilitating full understanding instances. However, those skilled in the art may understand that practice may be performed without these specific details.

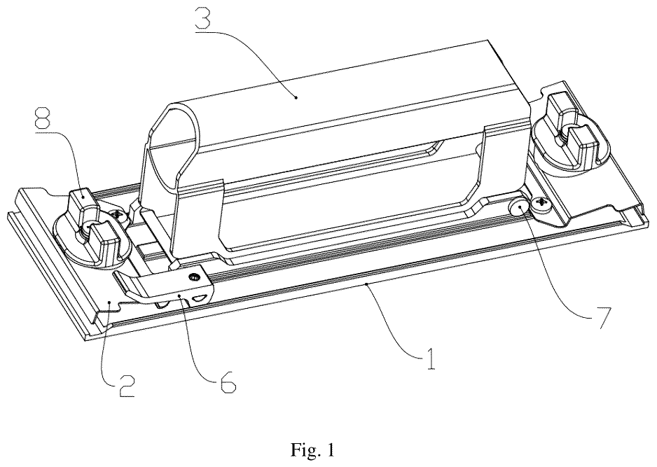

In conjunction with FIG. 1 to FIG. 13, the present application provides a quick-detachable dual-purpose abrasive paper grinding board, including: a grinding board bottom board 1, paper clamping boards 2, a quick-detachable grasping head and a movable locking member 6; the grinding board bottom board 1 is used for mounting abrasive paper, and the movable locking member 6 is used for locking and positioning the quick-detachable grasping head; and the paper clamping boards 2 are used for clamping or releasing the abrasive paper, a bottom face of the grinding board bottom board 1 is directly in contact with the abrasive paper, two ends of the abrasive paper are folded to an upper end face of the grinding board bottom board 1, and then the two ends of the abrasive paper are compressed by downwards pressing the paper clamping boards 2. The paper clamping boards are symmetrically and movably mounted at an upper end of the grinding board bottom board 1, a mounting groove 101 is formed in the upper end face of the grinding board bottom board 1 in a length direction in an extension mode, and the quick-detachable grasping head is detachably mounted in the mounting groove 101.

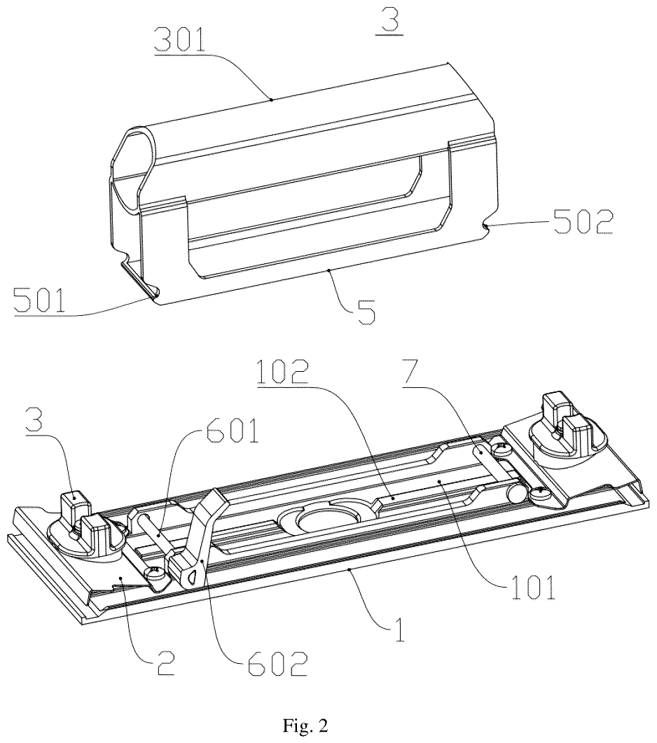

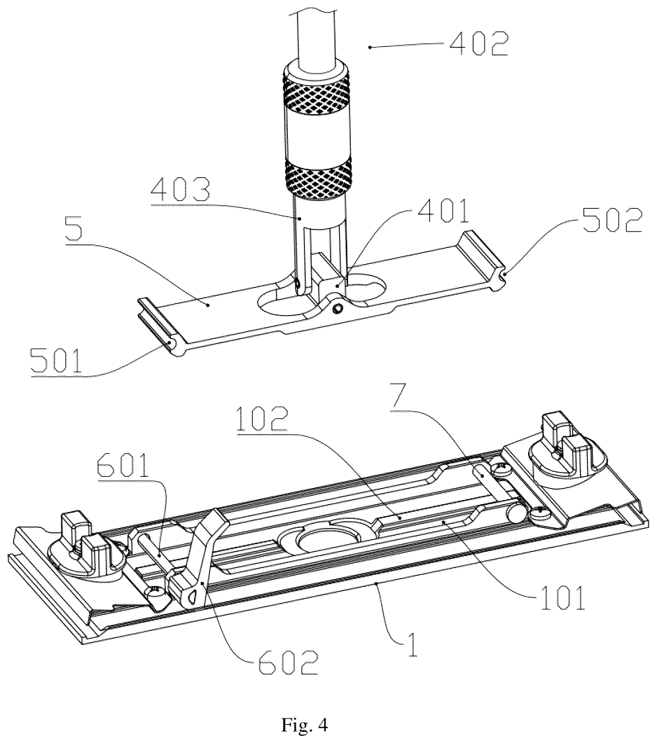

As shown in FIG. 1 to FIG. 4, the quick-detachable grasping head includes a grip quick-detachable head 3 or an extension bar quick-detachable head 4, and an operator may select to use the grip quick-detachable head 3 or the extension bar quick-detachable head 4 according to actual using scenarios; the grip quick-detachable head 3 or the extension bar quick-detachable head 4 is provided with a positioning bottom board 5 used for quick-detaching positioning; and the movable locking member 6 is rotatably mounted on the grinding board bottom board 1 and used for locking and positioning the positioning bottom board 5, and as shown in FIG. 2 and FIG. 4, the movable locking member 6 is rotatably mounted on one side of the mounting groove 101.

It needs to be noted that the extension bar quick-detachable head 4 is especially suitable for processing a surface of a higher or farther object, for example, when a putty wall at a higher position or a suspended putty wall is ground, the extension bar quick-detachable head 4 is needed.

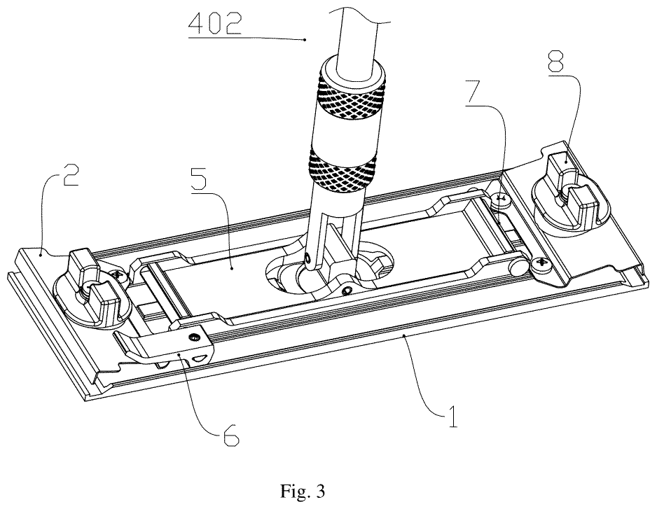

As shown in FIG. 1 to FIG. 4, the movable locking member 6 has an unlocking position and a locking position, at the locking position (as shown in FIG. 1 and FIG. 3), the movable locking member 6 locks the positioning bottom board 5 inside the mounting groove 101; and at the unlocking position (as shown in FIG. 2 and FIG. 4), the movable locking member 6 is detached from the positioning bottom board 5, and the grip quick-detachable head 3 or the extension bar quick-detachable head 4 may be removed from the mounting groove 101.

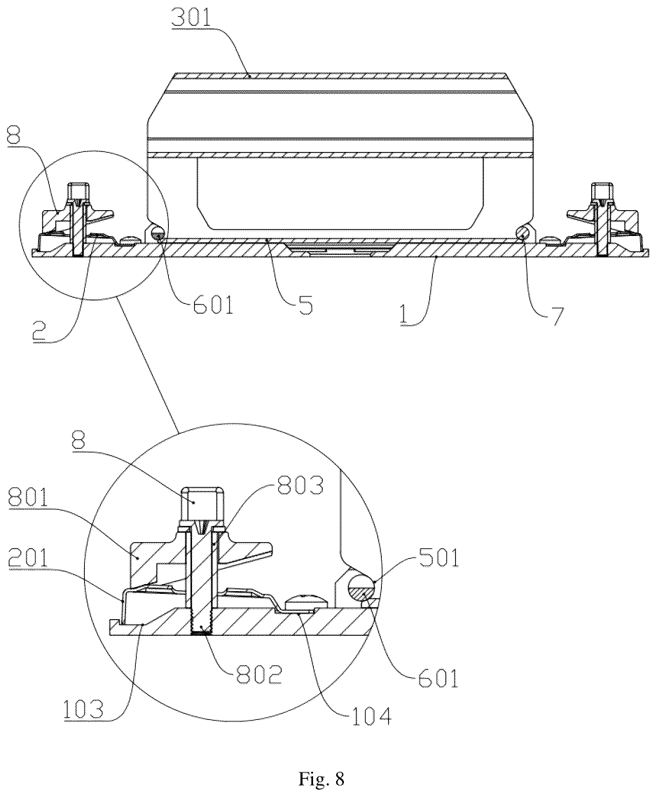

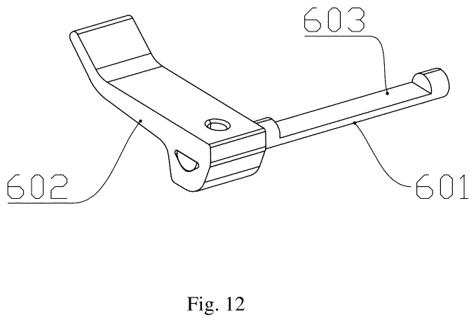

In a preferred embodiment, as shown in FIG. 8 and FIG. 12, the movable locking member 6 includes a locking dog 601 which is eccentrically arranged, a first locking groove 501 which is inwards concave is formed in a side end of the positioning bottom board 5, by rotating the locking dog 601 of the movable locking member 6, the locking dog 601 and the first locking groove 501 are locked or detached, as shown in FIG. 8, and at the moment, the locking dog 601 is matched with the first locking groove 501; one end of the locking dog 601 is connected with an eccentric handle 602, and the locking dog 601 and the first locking groove 501 are driven to be locked or detached by rotating the eccentric handle 602; and the eccentric handle 602 is provided with a locking face, and when the movable locking member 6 is at the locking position, the locking face is locked and attached on the upper end face of the grinding board bottom board 1. As shown in FIG. 1 and FIG. 3, when the eccentric handle 601 of the movable locking member 6 rotates into the locking position, the locking face is attached and self-locked on the upper end face of the grinding board bottom board 1, and therefore, if the eccentric handle 601 is not reversely rotated, the locking dog 6 will always compress and lock to an interior of the first locking groove 501 of the corresponding positioning bottom board 5.

As shown in FIG. 2 and FIG. 4, the locking dog 601 is arranged extending in a width direction of the grinding board bottom board 1, and the first locking groove 501 is arranged extending in a width direction of the grip quick-detachable head 3.

In an example, as shown in FIG. 12, the locking dog 601 eccentrically arranged in the present embodiment is implemented by cutting a segment of notch 603 in an optical axis.

In a preferred embodiment, a second locking groove 502 which is inwards concave is formed in a side end of the positioning bottom board 5 away from the first locking groove 501, the mounting groove 101 is provided with a clamping shaft 7 capable of being clamped with the second locking groove 502 on a side away from the movable locking member 6, the clamping shaft 7 is arranged extending in the width direction of the grinding board bottom board 1, and the second locking groove 502 is arranged extending in the width direction of the grip quick-detachable head 3; and when the positioning bottom board 5 is mounted, the second locking groove 502 in one end of the positioning bottom board 5 is clamped into the clamping shaft 7, and the movable locking member 6 is rotated to enable the locking dog 601 to make contact with the first locking groove 501 so as to be clamped. When the positioning bottom board 5 is placed into the mounting groove 101, the positioning bottom board 5 is firstly matched with the clamping shaft 7 at the mounting groove 101 through the second locking groove 502 to achieve primary positioning, and then through the locking cooperation of the movable locking member 6 with the first locking groove 501 of the positioning bottom board 5, locking and positioning of the entire positioning bottom board 5 may be achieved, namely, locking and positioning of the two quick-detachable heads are achieved.

As shown in FIG. 2 or FIG. 4, the clamping shaft 7 and the locking dog 601 are arranged in parallel, and the clamping shaft 7 is an optical axis; as shown in FIG. 12, the locking dog 601 is an optical axis with a notch 603, and when the movable locking member 6 is at the unlocking position, the notch 603 faces the first locking groove 501, such that at the moment, the locking dog 601 is not in contact with the first locking groove 501; and as shown in FIG. 8, when the movable locking member 6 is at the locking position, at the moment, the notch 603 is away from the notch 603, such that the locking dog 601 directly abuts against the first locking groove 501 to form locking and positioning.

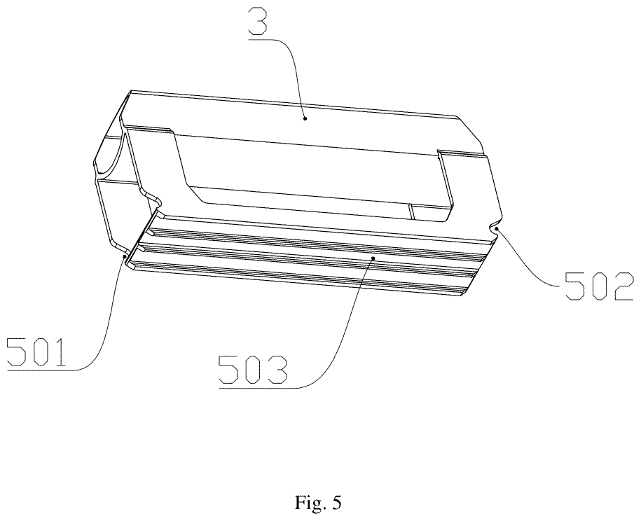

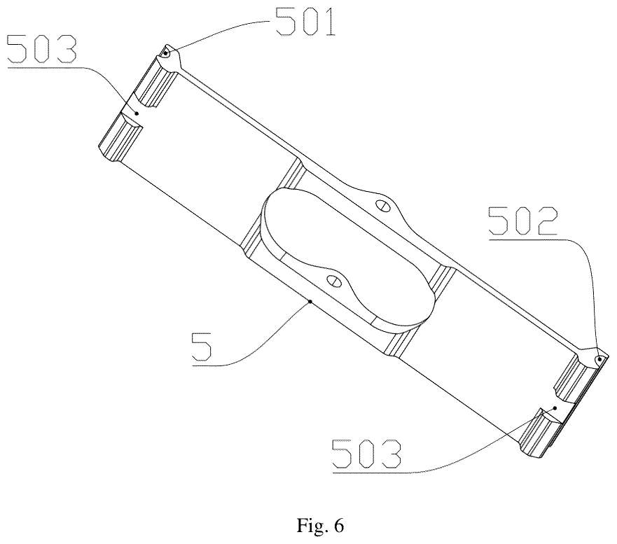

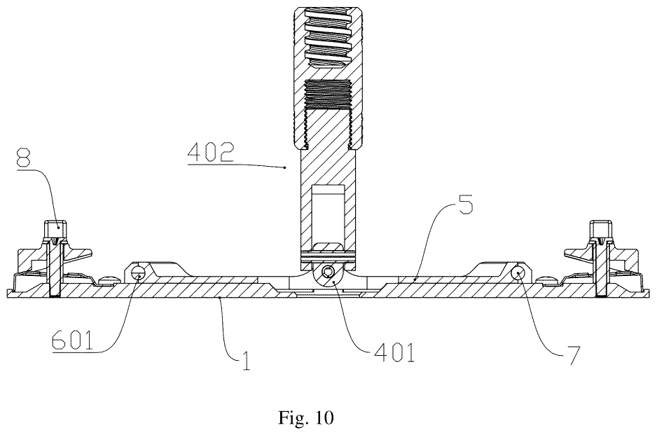

As shown in FIG. 5 and FIG. 6, the first locking groove 501 and the second first locking groove 502 are inwards-concave arc-shaped, therefore, as seen from a sectional diagram of FIG. 8 and FIG. 10, after the locking dog 601 is matched with the first locking groove 501, and the clamping shaft 7 is matched with the second locking groove 502, the positioning bottom board 5 cannot be directly removed from a vertical direction.

In an example, as shown in FIG. 2 and FIG. 5, the grip quick-detachable head 3 includes the positioning bottom board 5 and a grip 301 for an operator to grasp, namely, the operator may directly take the abrasive paper grinding board in hand; and in the present embodiment, the grip 301 of the grip quick-detachable head 3 is integrally molded with the positioning bottom board 5.

In another example, as shown in FIG. 3, FIG. 4 and FIG. 6, the extension bar quick-detachable head 4 includes the positioning bottom board 5 and an extension bar member 402 in hinged connection through a universal joint 401. The extension bar quick-detachable head 4 may grind a surface of a farther object, its extension bar member 402 is similar to a mop rod of a household flat mop, and the extension bar member 402 may achieve rotation adjustment in a front-rear direction or in a left-right direction relative to the positioning bottom board 5. The extension bar member 402 is hinged to the universal joint 401 through a hinged shaft 403, and then hinged to a hinged seat of the corresponding positioning bottom board 5 through the universal joint 401, and after the extension bar quick-detachable head 4 is mounted on the grinding board bottom board 1, the extension bar member 402 may rotate in a front-rear direction (the width direction of the grinding board bottom board 1) or in a left-right direction (a length direction of the grinding board bottom board 1) relative to the entire grinding board bottom board 1.

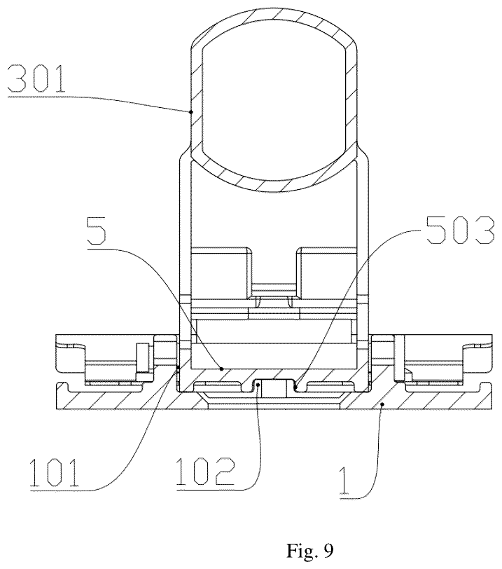

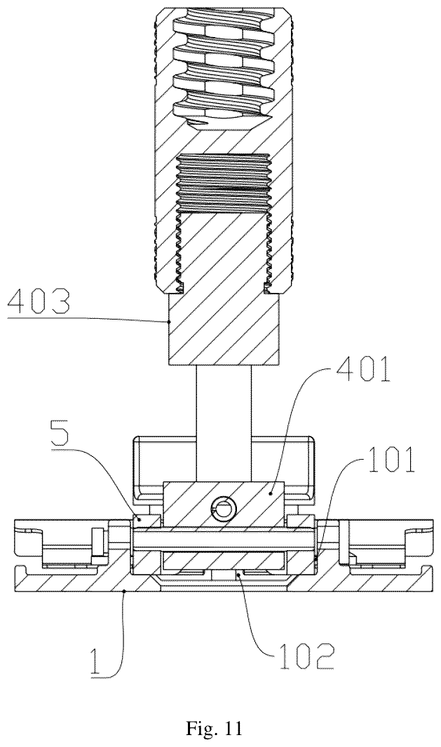

In some embodiments, as shown in FIG. 5 or FIG. 6, and FIG. 9 or FIG. 11, a guide groove 503 is correspondingly formed in a bottom of the positioning bottom board 5 of the grip quick-detachable head 3 or the extension bar quick-detachable head 4 in a length direction in a cut-through mode; and as shown in FIG. 2 or FIG. 4, a guide protrusion 102 capable of being matched with the guide groove 503 is arranged at a bottom of the mounting groove 101.

In the present embodiment, the guide groove 503 is formed in a middle position of a bottom face of the positioning bottom board 5, the guide protrusion 102 is arranged at a middle position of an inner wall of the mounting groove 101, and the positioning bottom board 5 may be centered and positioned through the cooperation of the guide groove 503 and the guide protrusion 102.

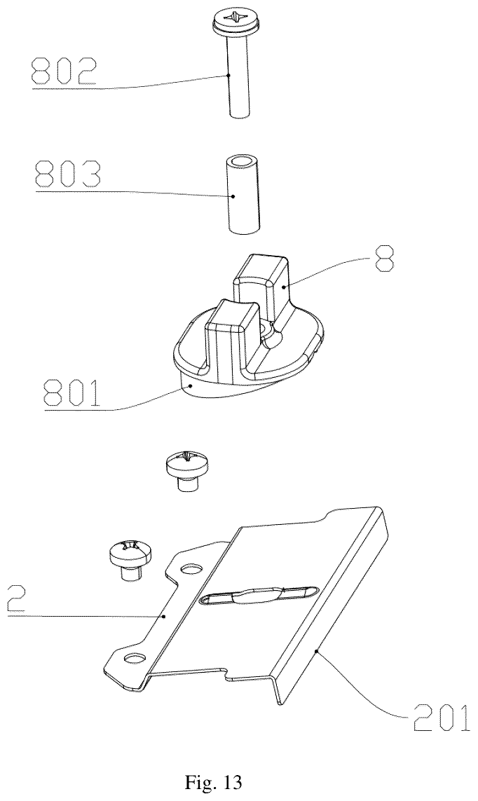

In some embodiments, as shown in FIG. 1 to FIG. 4, FIG. 8 and FIG. 13, control knobs 8 are rotatably mounted on the paper clamping boards 2, downwards-pressing cam portions 801 are arranged at lower ends of the control knobs 8, and the downwards-pressing cam portions 801 are used for downwards pressing paper clamping claws 201 of the paper clamping boards 2 to be close to or away from the upper end face of the grinding board bottom board 1, so as to clamp or release the abrasive paper; and as shown in FIG. 8 and FIG. 10, at the moment, the paper clamping claws 201 may clamp the abrasive paper to the grinding board bottom board 1 after being downwards pressed by the downwards-pressing cam portions 801.

In an example, as shown in FIG. 1 and FIG. 8, the paper clamping boards 2 are elastic members, and specifically are elastic sheets.

As shown in FIG. 8 and FIG. 13, the control knobs 8 are rotatably mounted on the grinding board bottom board 1 through mounting bolts 802 and guide sleeves 803. The downwards-pressing cam portions 801 sleeve the guide sleeves 803, and may rotate on the guide sleeves 803, and the guide sleeves 803 are fixed to the grinding board bottom board 1 through the mounting bolts 802.

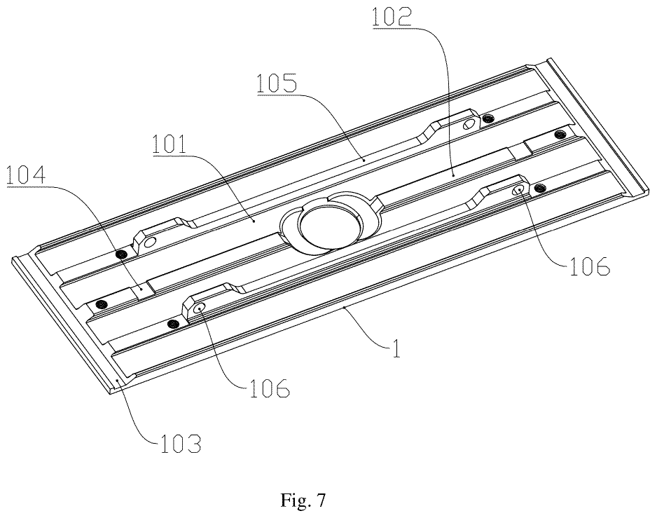

In a preferred embodiment, as shown in FIG. 7 and FIG. 8, inwards-concave clamping grooves 103 corresponding to the paper clamping claws 201 of the paper clamping boards 2 are formed in the upper end face of the grinding board bottom board 1, and by arranging the inwards-concave clamping grooves 103, further locking and positioning of the abrasive paper are facilitated, such that the abrasive paper is not prone to releasing from the inwards-concave clamping grooves 103; and FIG. 8 is a schematic structural diagram illustrating that the paper clamping claws 201 are downwards pressed into the inwards-concave clamping grooves 103.

In an embodiment, as shown in FIG. 7 and FIG. 8, sink grooves 104 used for positioning the paper clamping boards 2 are further formed in the upper end face of the grinding board bottom board 1, and the paper clamping boards 2 are fixed through fastener bolts after being positioned and placed in the sink grooves 104; and the sink grooves 104 may be formed in the guide protrusions 102.

In a preferred embodiment, as shown in FIG. 7, two vertical boards 105 are symmetrically arranged on the grinding board bottom board 1, a mounting groove 101 is formed between the two vertical boards 105, and a locking dog 601 used for mounting a movable locking member 6 and a mounting hole 106 used for mounting a clamping shaft 7 are mounted on two sides of the vertical boards 105. It needs to be noted that the mounting hole 106 of the present embodiment may be used for mounting the locking dog 601 or the clamping shaft 7, therefore, as shown in FIG. 1, the movable locking member 6 may be mounted at a left side position of the grinding board bottom board 1, and may also be mounted at a right side position of the grinding board bottom board 1.

Based on the same inventive concept, an embodiment of the present specification further provides a using method of the quick-detachable dual-purpose abrasive paper grinding board based on any one of the above-mentioned embodiments, and a grip quick-detachable head 3 or an extension bar quick-detachable head 4 is optionally mounted on a grinding board bottom board 1 of the abrasive paper grinding board;
when the grip quick-detachable head 3 is selected to use, firstly the grip quick-detachable head 3 is placed into a mounting groove 101 of the grinding board bottom board 1; secondly a second locking groove 502 of a positioning bottom board 5 of the grip quick-detachable head 3 is clamped at a clamping shaft 7 on one side of the mounting groove 101 for primary positioning; then an eccentric handle 602 of a movable locking member 6 is rotated to enable a locking dog 601 to be in lock fit with a first locking groove 501 of the positioning bottom board 5 corresponding to the grip quick-detachable head 3, the movable locking member 6 enters a locking position, and at the moment, an operator may directly grasp a grip 301 of the grip quick-detachable head 3 by hand for use; and
when the grip quick-detachable head 3 is replaced with the extension bar quick-detachable head 4, the eccentric handle 602 of the movable locking member 6 is reversely rotated to enable the locking dog 601 to be detached from the first locking groove 501 in one side of the grip quick-detachable head 3, and in a process of removing the grip quick-detachable head 3 upwards, the clamping shaft 7 is detached from the second locking groove 502 of the positioning bottom board 5; and then the extension bar quick-detachable head 4 is placed and locked by the movable locking member 6, and at the moment, the operator may directly grasp an extension bar member 402 of the extension bar quick-detachable head 4 by hand for use.

It needs to be noted that a mounting method of the extension bar quick-detachable head 4 is the same as that of the grip quick-detachable head 3, namely, when the extension bar quick-detachable head 4 is mounted, firstly the positioning bottom board 5 of the extension bar quick-detachable head 4 is placed into the mounting groove 101 of the grinding board bottom board 1; secondly the second locking groove 502 of the positioning bottom board 5 is clamped at the clamping shaft 7 on one side of the mounting groove 101 for primary positioning; and then the eccentric handle 602 of the movable locking member 6 is rotated to enable the locking dog 601 to be in lock fit with the first locking groove 501 of the positioning bottom board 5 corresponding to the extension bar quick-detachable head 4, and the movable locking member 6 enters a locking position. As shown in FIG. 3 and FIG. 10, at the moment, the locking dog 601 of the movable locking member 6 is at the locking position.

The above using method of the abrasive paper grinding board is simple and convenient to operate; and the same abrasive paper grinding board has two functions of grasping by the grip and adopting the extension bar to extend to grind the surface of a farther or higher object.

When the positioning bottom board 5 corresponding to the grip quick-detachable head 3 or the extension bar quick-detachable head 4 is placed into the mounting groove 101, the guide groove 503 in the bottom of the positioning bottom board 5 is centered and matched with the guide protrusion 102 in the mounting groove 101; and the locking dog 601 and the clamping shaft 7 are respectively arranged extending in the width direction of the grinding board bottom board 1.

As shown in FIG. 1 or FIG. 3, the grip quick-detachable head 3 includes a grip 301 capable of being used by the operator for grasping, and the extension bar quick-detachable head 4 includes an extension bar member 402 capable of rotating and hinging relative to the positioning bottom board 5.

In some embodiments, when abrasive paper is mounted, two ends of the abrasive paper are folded into inwards-concave clamping grooves 103 in the upper end face of the grinding board bottom board 1. As shown in FIG. 8, by rotating the control knobs 8 on the paper clamping boards 2, the downwards-pressing cam portions 801 of the control knobs 8 downwards press the paper clamping claws 201 of the paper clamping boards 2, such that the paper clamping claws 201 are in contact with and compress the abrasive paper into the inwards-concave clamping grooves 103.

For the same or similar parts between the embodiments in the present specification, reference may be made to each other. Each embodiment focuses on differences from other embodiments. Especially for the embodiment described later, the description is relatively simple, and the relevance refers to the partial specification of the above-mentioned embodiment.

The foregoing descriptions are merely a specific implementation of the present application, but are not intended to limit the scope of protection of the present application. Any variation or replacement readily figured out by a person skilled in the art within the technical scope disclosed in the present application shall fall within the scope of protection of the present application. Therefore, the scope of protection of the present application shall be subject to the scope of protection of the claims.

What is claimed is:

1. A quick-detachable dual-purpose abrasive paper grinding board, comprising:
a grinding board bottom board (1), used for mounting abrasive paper; wherein a mounting groove (101) is formed in an upper end face of the grinding board bottom board (1) in a length direction in an extension mode;
paper clamping boards (2), symmetrically and movably mounted at an upper end of the grinding board bottom board (1), and used for clamping or releasing the abrasive paper;
a quick-detachable grasping head, detachably mounted in the mounting groove (101); wherein the quick-detachable grasping head comprises a grip quick-detachable head (3) or an extension bar quick-detachable head (4), and the grip quick-detachable head (3) or the extension bar quick-detachable head (4) is provided with a positioning bottom board (5) used for quick-detaching positioning; and
a movable locking member (6), rotatably mounted on the grinding board bottom board (1), and used for locking the positioning bottom board (5); wherein the movable locking member (6) has an unlocking position and a locking position, at the locking position, the movable locking member (6) locks the positioning bottom board (5) inside the mounting groove (101); and at the unlocking position, the movable locking member (6) is detached from the positioning bottom board (5), and the grip quick-detachable head (3) or the extension bar quick-detachable head (4) is able to be removed from the mounting groove (101).

2. The quick-detachable dual-purpose abrasive paper grinding board according to claim 1, wherein the movable locking member (6) comprises a locking dog (601) which is eccentrically arranged, a first locking groove (501) is formed in a side end of the positioning bottom board (5), and by rotating the locking dog (601) of the movable locking member (6), the locking dog (601) and the first locking groove (501) are locked or detached; and the locking dog (601) is arranged extending in a width direction of the grinding board bottom board (1), and the first locking groove (501) is arranged extending in a width direction of the grip quick-detachable head (3).

3. The quick-detachable dual-purpose abrasive paper grinding board according to claim 2, wherein one end of the locking dog (601) is connected with an eccentric handle (602), and the locking dog (601) and the first locking groove (501) are driven to be locked or detached by rotating the eccentric handle (602); and/or, the eccentric handle (602) is provided with a locking face, and when the movable locking member (6) is at the locking position, the locking face is locked and attached on the upper end face of the grinding board bottom board (1).

4. The quick-detachable dual-purpose abrasive paper grinding board according to claim 3, wherein a second locking groove (502) is formed in a side end of the positioning bottom board (5) away from the first locking groove (501), the mounting groove (101) is provided with a clamping shaft (7) capable of being clamped with the second locking groove (502) on a side away from the movable locking member (6), the clamping shaft (7) is arranged extending in the width direction of the grinding board bottom board (1), and the second locking groove (502) is arranged extending in the width direction of the grip quick-detachable head (3); and/or, the first locking groove (501) is inwards concave, and the second locking groove (502) is inwards concave; when the positioning bottom board (5) is mounted, the second locking groove (502) in one end of the positioning bottom board (5) is clamped into the clamping shaft (7), and the movable locking member (6) is rotated to enable the locking dog (601) to make contact with the first locking groove (501) so as to be clamped; and/or, a guide groove (503) is formed in a bottom of the positioning bottom board (5) in a length direction in a cut-through mode, and a guide protrusion (102) capable of being matched with the guide groove (503) is arranged at a bottom of the mounting groove (101).

5. The quick-detachable dual-purpose abrasive paper grinding board according to claim 1, wherein the grip quick-detachable head (3) comprises the positioning bottom board (5) and a grip (301) for an operator to grasp; and/or, the grip (301) of the grip quick-detachable head (3) is integrally molded with the positioning bottom board (5).

6. The quick-detachable dual-purpose abrasive paper grinding board according to claim 1, wherein the extension bar quick-detachable head (4) comprises the positioning bottom board (5) and an extension bar member (402) in hinged connection through a universal joint (401).

7. The quick-detachable dual-purpose abrasive paper grinding board according to claim 1, wherein control knobs (8) are rotatably mounted on the paper clamping boards (2), downwards-pressing cam portions (801) are arranged at lower ends of the control knobs (8), and the downwards-pressing cam portions (801) are used for downwards pressing paper clamping claws (201) of the paper clamping boards (2) to be close to or away from the upper end face of the grinding board bottom board (1), so as to clamp or release the abrasive paper; and/or, inwards-concave clamping grooves (103) corresponding to the paper clamping claws (201) of the paper clamping boards (2) are formed in the upper end face of the grinding board bottom board (1); sink grooves (104) used for positioning the paper clamping boards (2) are further formed in the upper end face of the grinding board bottom board (1);
and/or, the control knobs (8) are rotatably mounted on the grinding board bottom board (1) through mounting bolts (802) and guide sleeves (803).

8. A using method of a quick-detachable dual-purpose abrasive paper grinding board, implemented based on the quick-detachable dual-purpose abrasive paper grinding board according to claim 4, wherein a grip quick-detachable head (3) or an extension bar quick-detachable head (4) is optionally mounted on a grinding board bottom board (1);
when the grip quick-detachable head (3) is selected to use, firstly the grip quick-detachable head (3) is placed into a mounting groove (101) of the grinding board bottom board (1); secondly a second locking groove (502) of a positioning bottom board (5) of the grip quick-detachable head (3) is clamped at a clamping shaft (7) on one side of the mounting groove (101) for primary positioning; then an eccentric handle (602) of a movable locking member (6) is rotated to enable a locking dog (601) of the movable locking member (6) to be in locking fit with a first locking groove (501) of the corresponding positioning bottom board (5), the movable locking member (6) enters a locking position, and at the moment, an operator may directly grasp a grip (301) of the grip quick-detachable head (3) by hand for use; and
when the grip quick-detachable head (3) is replaced with the extension bar quick-detachable head (4), the eccentric handle (602) of the movable locking member (6) is reversely rotated to enable the locking dog (601) to be detached from the first locking groove (501) in one side of the grip quick-detachable head (3), and in a process of removing the grip quick-detachable head (3) upwards, the clamping shaft (7) is detached from the second locking groove (502) of the corresponding positioning bottom board (5); and then the extension bar quick-detachable head (4) is placed and locked, and at the moment, the operator may directly grasp an extension bar member (402) of the extension bar quick-detachable head (4) by hand for use.

9. The using method of the quick-detachable dual-purpose abrasive paper grinding board according to claim 8, wherein a mounting method of the extension bar quick-detachable head (4) is the same as that of the grip quick-detachable head (3); and/or, when the positioning bottom board (5) corresponding to the grip quick-detachable head (3) or the extension bar quick-detachable head (4) is placed into the mounting groove (101), a guide groove (503) in a bottom of the positioning bottom board (5) is matched with a guide protrusion (102) in the mounting groove (101); and/or, the locking dog (601) and the clamping shaft (7) are respectively arranged extending in a width direction of the grinding board bottom board (1).

10. The using method of the quick-detachable dual-purpose abrasive paper grinding board according to claim 8, wherein when abrasive paper is mounted, two ends of the abrasive paper are folded into inwards-concave clamping grooves (103) in an upper end face of the grinding board bottom board (1), and control knobs (8) on paper clamping boards (2) are rotated to enable downwards-pressing cam portions (801) of the control knobs (8) to downwards press paper clamping claws (201) of the paper clamping boards (2), so that the paper clamping claws (201) are in contact with and compress the abrasive paper into the inwards-concave clamping grooves (103).
